(19) United States
(12) Patent Application Publication
(10) Pub. No.: US 2014/0194673 A1
(43) Pub. Date: Jul. 10, 2014

(54) PIEZOELECTRIC-BASED, SELF-SUSTAINING ARTIFICIAL COCHLEA

(71) Applicant: Wright State University, Dayton, OH (US)

(72) Inventors: Robert A. Goldenberg, Dayton, OH (US); Yan Zhuang, Dayton, OH (US); Jared Allen Evans, Beavercreek, OH (US)

(73) Assignee: Wright State University, Dayton, OH (US)

(21) Appl. No.: 14/142,064

(22) Filed: Dec. 27, 2013

Related U.S. Application Data
(60) Provisional application No. 61/749,698, filed on Jan. 7, 2013.

(51) Int. Cl. H04R 25/00

(52) U.S. Cl. CPC H04R 25/48; H04R 25/608
USPC 600/25; 29/25.35

(57) ABSTRACT

Piezoelectric transducer arrays and methods of making the same are discussed. Such an array can include a piezoelectric film comprising a plurality of segments. Adjacent segments can be separated by trenches of a plurality of trenches in the piezoelectric film. Additionally, such an array can include a plurality of electrodes attached to the plurality of segments.

### CROSS-REFERENCE TO RELATED APPLICATIONS

This application claims the benefit of pending U.S. Provisional Patent application Ser. No. 61/749,698 (Atty. Dkt. No. 107493.5PRO) entitled ‘Totally Implantable, Self-Sustained and Readjustable Artificial Cochlea’ and filed Jan. 7, 2013. The entirety of the above-noted application is incorporated by reference herein.

### BACKGROUND

According to the National Center for Health Statistics (HCHS) of the U.S. Department of Health and Human Services, an estimated 20,295,000 people, of 8.6% of the U.S. population 3 years or older, are reported to have hearing problems. Hearing impairment can result from a number of conditions, including hereditary or birth problems, ear infections, head trauma, and otosclerosis, or from age related hearing loss, which is the most common. Excessive or prolonged noise exposure in industry, military, or recreational environments can produce onset of hearing loss symptoms as well.

In light of these auditory statistics, understanding the functionality of the ear is essential to remedying the ailment. The human ear consists of three sections, the outer ear, the middle ear, and the inner ear. The outer ear functions to collect sound waves and funnel them to the middle ear mechanisms. Sound waves travelling through the air are captured by the auricle and intensified by the ear canal, inciting vibrations of the ear drum. These vibrations excite the three bones of the middle ear, the ossicles, which serve to mechanically amplify the sound. The mechanical oscillations transfer the waves to the inner ear.

The inner ear houses the components, which convert sound waves to electrical signals and stimulate the hearing centers of the brain. After amplification by the ossicles, compression waves are generated in the extracellular perilymph fluid in the scala tympani and scala vestibuli of the spiral-shaped cochlea. The fluid displacement stimulates a structure called the basilar membrane, housed in the approximately 30 mm length of the spiral structure. The basilar membrane vibrates selectively along its length based on the frequency of the incoming signal; this selectivity is due to its varying stiffness and size. The basilar membrane responds to higher frequencies near the base and lower frequencies near the apex.

As pressure displaces the basilar membrane, the movement stimulates receptors called hair cells, which convert the vibrations to electrical signals. The movement of the inner hair creates a potential difference, between 5-10 millivolts from the resting state, while outer hair cells act to control the total output. The resulting electrical signal stimulates nerve bundles connected to the brain, leading to what is perceived as hearing.

Two classifications can be used to describe hearing loss, regarding which section of the ear is impaired: conduction deafness and sensorineural deafness. Conduction deafness refers to problems originating in the outer and middle ear, including blockage of the ear canal, damage to the tympanic membrane, ear infections, and decreased movement of the ossicles. Sensorineural deafness results from impariment of the hair cells and surrounding structures and the auditory nerve.

Conduction deafness can be treated with hearing aids, which amplify sounds entering the outer ear, or surgical reconstruction of the impaired structures. Sensorineural deafness may be remedied with hearing aids for mild cases, or cochlear implants for severe loss. Cochlear implants directly stimulate the nerves of the inner ear using both external and implanted devices. For significant nerve deafness and damage to the inner ear, where hearing aids are not effective to attain useful hearing, cochlear implants can provide a wider range of benefits.

A conventional cochlear implant is a battery-powered, external device that is worn over the ear and attached to the skull. It generally consists of a microphone to receive sound, a signal processor to process sound into electrical signals, external and internal magnetically implanted coils, and electrodes that are inserted into the cochlea to stimulate the cochlear nerve. It has been in clinical use for nearly 30 years. There are some aesthetic and functional concerns about the external portion of the device, and the sound quality of speech and music is not entirely satisfactory. The system also requires that the battery be replaced or recharged.

Conventional cochlear implants from several manufacturers each utilize a similar procedure for digitalizing sound and applying it to the nerves of the inner ear. In contrast, each have different benefits towards size, reliability, electrode quantity, and additional features. The process of implanting the electrode array usually destroys any remnant hearing and therefore is typically only used for extreme cases of hearing loss; however, hybrid implants are being developed which preserve residual, low-frequency hearing, while restoring high-frequency hearing loss.

### SUMMARY

The following presents a simplified summary of the innovation in order to provide a basic understanding of some aspects of the innovation. This summary is not an extensive overview of the innovation. It is not intended to identify key/critical elements of the innovation or to delineate the scope of the innovation. Its sole purpose is to present some concepts of the innovation in a simplified form as a prelude to the more detailed description that is presented later.

Hearing loss is a prevalent issue, affecting all ages in innumerable occupations. Cochlear implants are one solution to sensorineural hearing complications; and though they are commonly used, conventional electronic devices have limitations in power consumption and external equipment. Piezoelectric films emulate the relationship between the basilar membrane and inner hair cell structures of the human cochlear epithelium, inducing a potential difference in response to sound pressure. The subject innovation, in various embodiments, can comprise an artificial cochlea developed utilizing piezoelectrics, which can be self-sustainable and can function naturally with the mechanisms of the human ear.

The innovation disclosed and claimed herein, in one aspect thereof, comprises a piezoelectric transducer array. Such an array can include a piezoelectric film comprising a plurality of segments. Adjacent segments can be separated by trenches of a plurality of trenches in the piezoelectric film. Additionally, such an array can include a plurality of electrodes attached to the plurality of segments.

In another aspect, the subject innovation can comprise a method. Such a method can include the acts of obtaining a piezoelectric film and etching a plurality of trenches in the piezoelectric film. The plurality of trenches can define a plurality of segments of the piezoelectric film. Additionally, the method can include attaching a plurality of electrodes to the plurality of segments.

To the accomplishment of the foregoing and related ends, certain illustrative aspects of the innovation are described herein in connection with the following description and the annexed drawings. These aspects are indicative, however, of but a few of the various ways in which the principles of the innovation can be employed and the subject innovation is intended to include all such aspects and their equivalents. Other advantages and novel features of the innovation will become apparent from the following detailed description of the innovation when considered in conjunction with the drawings.

### BRIEF DESCRIPTION OF THE DRAWINGS

FIG. 1 illustrates a method that can facilitate fabrication of a piezoelectric transducer array in accordance with aspects of the subject innovation.

FIG. 2 illustrates a simulated model of a piezoelectric transducer array in accordance with aspects of the subject innovation.

FIG. 3 illustrates the substrate model used in experiments discussed herein, with the deposited film and electrode.

FIG. 4 illustrates a visual representation of the 40 micron response of a simulated segment in accordance with aspects of the subject innovation.

FIG. 5 illustrates a visual representation of the 20 micron response of a simulated segment in accordance with aspects of the subject innovation.

FIG. 6 illustrates a graph of width vs. resonant frequency for constant 30 mm length of a segment in accordance with aspects of the subject innovation.

FIG. 7 illustrates the response of a 12 segment device at high frequency.

FIG. 8 illustrates the response of a 12 segment device at low frequency.

FIG. 9 illustrates a comparison between simulated and experimental width vs. resonant frequency results.

FIG. 10 illustrates an example placement of a cochlear implant according to aspects of the subject innovation.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding of the subject innovation. It may be evident, however, that the innovation can be practiced without these specific details. In other instances, well-known structures and devices are shown in block diagram form in order to facilitate describing the innovation.

As used in this application, the terms “component”, “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, or a computer. By way of illustration, both an application running on a controller and the controller can be a component. One or more components residing within a process or thread of execution and a component may be localized on one computer or distributed between two or more computers.

Furthermore, the claimed subject matter can be implemented as a method, apparatus, or article of manufacture using standard programming or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

Normal hearing occurs when sound enters the external auditory canal and causes a vibration of the tympanic membrane. Sound is then amplified through the middle ear transformer mechanism which in turn creates a traveling wave in the inner ear fluid of the cochlea. This fluid wave stimulates the hair cells of the Organ of Corti. The mechanical excitation creates an electrical charge in each hair cell, which stimulates specific neurons of the auditory nerve; neural stimulation ascends the higher levels of the auditory pathway to the cortex of the brain, where sound is transformed into hearing. Except for individuals who have some form of cognitive impairment, the only defect of the auditory pathway for those with age related or noise induced hearing loss is in the hair cells in the Organ of Corti. Unlike conventional cochlear implants, this defect, and only this defect, is replaced with an artificial cochlea of the subject innovation. By utilizing all of the otherwise normally functioning components of the auditory pathway, reception of sounds will be much closer to normal hearing than with cochlear implants.

Systems and methods of the subject innovation can comprise piezoelectric transducer arrays and methods of making the same, wherein the piezoelectric transducer arrays can have characteristics of sufficient output to stimulate the inner hair cells and selective response to human speech frequencies. The number of frequency channels in such a piezoelectric transducer array can be based on the quantity of electrodes on the film.

The subject innovation can comprise a piezoelectric membrane, holding device, and possible amplifier and signal processing device. A piezoelectric is a natural transducer, converting pressure to electrical signals. Piezoelectrics, as with other materials, additionally have a mechanical property known as the resonant frequency, relating to the frequency at which the material will vibrate most readily, or in other words, convert mechanical stimulation to electrical output with the greatest efficiency. The resonant frequency can be altered by varying the dimensions of the piezoelectric film; therefore, having a structure with multiple, distinct segments, which thus resonate at different frequencies, can achieve a range covering normal human hearing. Based on the size of the film, its thickness, loading due to how the film is secured, and other material properties, the resonance region can be selectively altered. Designing the material around this parameter can maximize output, and can also isolate the responses of the membrane to select segments, as described herein.

In this embodiment, the piezoelectric membrane serves as a replacement for the aforementioned failing basilar membrane and inner hair cells of the Organ of Corti. Due to the characteristics of piezoelectric films, when sealed within the scala vestibuli of the cochlea, the piezoelectric vibrates in response to the pressure waves created in the perilymph fluids by the ossicles. Similar to the frequency selectivity of the basilar membrane due to its stiffness gradient, the piezoelectric film will stimulate select nerves by fabrication of the plurality of segments. If placed in close proximity to the auditory nerves, an output of 5-10 mV should be sufficient to stimulate hearing, foregoing the damaged inner ear.

The base of the embodiment can be a piezoelectric sheet, having a length between 20 mm and 30 mm, width of approximately 0.6 mm, and thickness of a few microns to 40 microns. Though ceramic piezoelectrics provide high outputs, highly noticeable piezoelectric effect in polymers, such as polyvinylidene difluoride (PVDF), have also been discovered. Polymeric piezoelectrics can provide advantages in this application over ceramics due to their favorable acoustic impedance, flexibility, and sufficient durability. These polymers could be PVDF, PVDF-TrFE, or any other suitable material with high output and bio-compatibility. In this embodiment, three major alterations can be made to the original piezoelectric film: etches on the topside for isolation, etches on the backside for increased vibrational amplitude, and electrode deposition in order to store manifested charge.

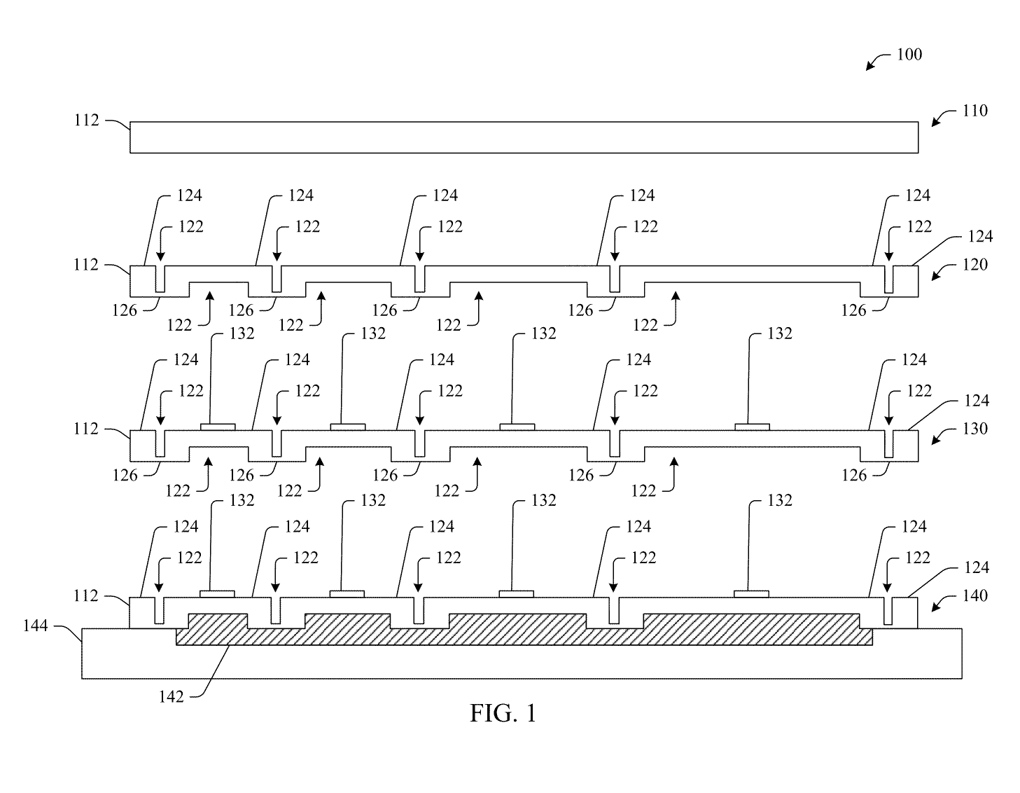

The piezoelectric film can be fabricated through Microelectromechanical system (MEMS) processing in order to provide mechanical channel isolation and greater film vibration. Referring initially to the drawings, FIG. 1 illustrates a method 100 that can facilitate fabrication of a piezoelectric transducer array in accordance with aspects of the subject innovation. A piezoelectric transducer array such as that discussed in connection with method 100 can address channel isolation. Method 100 can begin at step 110, by fabricating or obtaining a piezoelectric membrane 112. In various embodiments, the thickness of membrane 112 can be on the order of tens of microns; in an experiment discussed herein, the thickness was approximately 40 nm. At step 120, trenches 122 can be etched on the top of membrane 112 (e.g., with widths on the order of single microns, etc.) for isolation and on the bottom of membrane 112 for increased membrane displacement (these trenches can leave a membrane thickness on the order of single microns, e.g., 1-10 μm, etc.).

MEMS technology can be used in crafting trenches 122 in the piezoelectric film to isolate the segments 124, which can have varied lengths (and/or widths), which change the resonance characteristics. The backside etches similarly reduce the thickness of the film 112, resulting in not only a higher vibrational amplitude, leading to a greater voltage output, but also help in the isolation of the segments. In various embodiments, the lengths of the segments can monotonically decrease (or increase, from the other direction) along the length of the piezoelectric film, so that the frequency response of the film increases monotonically along the piezoelectric film (as it does along the basilar membrane due to the stiffness differential along its length). The dividing regions 126, being much thicker than the individual segments 124 (FIG. 1 is not to scale), will not readily vibrate and isolate the segments from each other. The width of the top side etches 122 can be less than 0.5 mm to avoid them having a noticeable resonance. The thickness of the segments 124 can be as small as possible, although some thickness to the film must be preserved in order to ensure the material is stable in regards to stresses generated during operation.

Next, at 130, electrodes 132 can be deposited on one or more of the segments 124 to create individual transducer elements, thus creating a piezoelectric transducer array in accordance with aspects of the subject innovation. At 140, relevant to some embodiments and to experimental results discussed herein, the piezoelectric transducer array can be exposed to fluid interactions similar to the inner ear mechanisms (e.g., for implantation, experimental or calibration purposes, etc.) by securing membrane 112 over a fluid channel 142, e.g., via a substrate or sample holder device 144. As the piezoelectric film is displaced, in order to generate a voltage, electrodes 132 (e.g., which can be metallic, etc.) can be deposited in the middle of each segment on both the top and bottom sides. These electrodes 132 serve to accumulate charge generated by the piezoelectric. Additionally, proper boundary conditions of the film can assure device operation. A holding device, detailed in the coming sections, can ensure the piezoelectric film of step 130 will remain relative to the desired auditory nerves when implanted in the cochlea. In other embodiments, at least a portion of the edges of membrane 112 can be secured to a holder for implantation without the inclusion of a fluid channel.

In one or more embodiments of the device, the transducer elements (e.g., combinations of segment 124 and electrode 132) can be mechanically isolated from each other and can provide enhanced yield due to the thinned material. The topside trenches 122 can be thin and cover the entire width of the membrane, which can reduce undesired output and can provide local stimulation to the nerves connected to the implant. In aspects, the etching can be done with dimethyl acetamide (DMA), a polymer etching agent tested with Poly(Vinyledene Diflouride) (PVDF). The electrodes 132 can be made from any highly conductive, bio-compatible metal (e.g., platinum or gold). The size of the electrodes will vary based on the output of the piezoelectric, though biocompatibility requires the charge density to be less than 32 uC/cm² to ensure safety of the relevant cells. Electrodes placement can be in the center of the segments, as the center will reach the highest displacement.

In one embodiment, the perilymph fluid of the inner ear can be replaced with a more conductive fluid to improve nerve bundle stimulation. The fluid 142 can affect the piezoelectric film through the sample holder device 144 and fill the entirety of the scala tympani and scala vestibuli. Any fluid lost during the implantation procedure can be replaced.

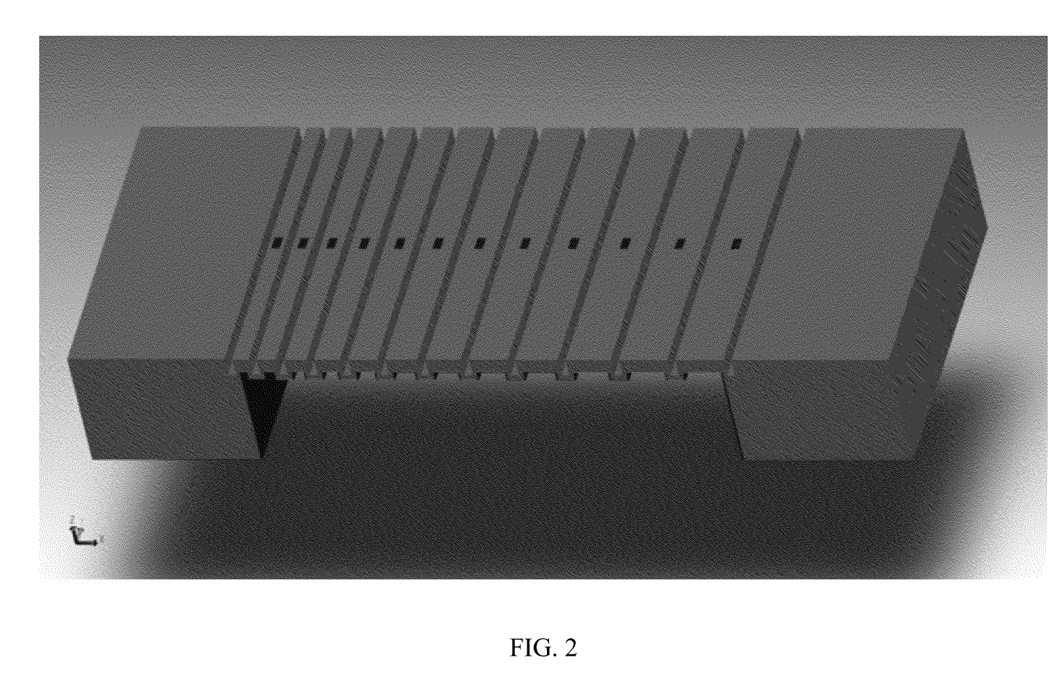

Referencing the basilar membrane structure, larger segments 124 will respond more readily to lower frequencies in this design, as the size endows increased loading to the segment 124, reducing the resonant frequency. Larger segments will respond most readily at lower frequencies, due to the general rule that the increased weight and loading of the segment will hinder the vibration and lower the resonant frequency. Likewise, high frequencies will resonate more readily on narrower sections 124. Adjustable thickness for each segment 124 permits tuning the resonant frequency of each individual structure (e.g., combination of segment 124 and electrode 132). Thinner segments 124 can result in higher vibrational amplitude and can result in greater output voltage; however, care should be taken in maintaining structural integrity of the device. FIG. 2 illustrates a simulated model of a piezoelectric transducer array in accordance with aspects of the subject innovation.

The number of segments and size of each segment controls the frequency range covered by the device. In various embodiments, the target range can be around 300-3500 Hz, which encompasses the normal speech range for humans. For different applications, this range can be adjusted to account for residual hearing effects in individuals or for different frequency range needs by adjusting the segment size and count. In one embodiment of the device, a 12 segment structure can be created, providing resonance from 5000 Hz to 10000 Hz with segment size varying linearly from 1 mm to 2.5 mm. In one such embodiment with 12 segments, the topside etches can be 0.5 mm and span the width of the film and the bottom etches can reduce the thickness of the film to around 10 um in order to increase the vibrational amplitude. Another embodiment of the device containing 9 segments can correspond to a frequency range of 3000 Hz to 8500 Hz. More segments can be added to provide a clearer representation of natural hearing; however, the segment number is limited by interference between neighboring electrodes. As the device is in a fluid environment and not directly adjacent to the targeted nerve bundle, electrical output from one electrode may stimulate unintentional auditory nerves. As more segments are added, the thickness of each segment, length of the piezoelectric film, and width of the piezoelectric film can be adjusted to ensure that the device corresponds to the desired frequency range.

The piezoelectric film 100, which is the basic structure of the subject innovation, is formed starting with commercially bought polymer resin, such as PVDF. This resin can then be melted to the proper thickness and sheet sizes required for the device substrate. This sheet can then be annealed to create a stable piezoelectric β-phase crystal structure. Introduction of a strong electric field serves to polarize the film, creating electric dipoles (separation of negative and positive charges within the material) and giving the material a permanent piezoelectric property. The resin used in this structure can include, but is not limited to, PVDF and poly[vinylidenefluoride-co-trifluoroethylene] (PVDF-TrFE). PVDF-TrFE is more durable and can achieve a higher piezoelectric response if required at the expense of flexibility.

The polarized piezoelectric can be subjected to further standard, MEMS fabrication procedures to develop the small-scale features of the device. Etching can create the isolation trenches between segments of the film, while deposition can create metallic electrodes, which serve to transfer charge from the piezoelectric to the auditory nerves. Photolithography masks consist generally of clear material substrate with a patterned metal deposited onto the substrate. First, a light sensitive compound is evenly coated on the piezoelectric and the mask place in proximity to the photoresist compound. When UV light is shown onto the mask, the light penetrates the clear region and develops the photoresist below. This developed photoresist can then be removed while the undeveloped portion remains. Through this method, patterns can be made on the piezoelectric film to selectively etch away the desired locations for both topside and bottom etches. Chemical wet etching can be used with a chemical like DMA or aqueous HCl (hydrochloric acid) for removal for the select polymer segments. Nonstandard chemicals can selectively remove the photoresist after etching is finished. Once these etches are completed, metal deposition can be done using the same masking techniques to place metal electrodes of desired sizes onto the top and bottom of the piezoelectric, in the center of the segments along with any other connections that require fabrication (e.g., lines connection to amplifier).

Systems and methods of the subject innovation can provide multiple benefits. Because of the use of piezoelectric materials discussed herein, which can be carefully chosen to respond ideally in the environment of the inner ear, the nerves controlling hearing can be stimulated in a more natural approach. The material can act as a replacement for failing basilar membrane or hair cells of the cochlea, working with the outer and middle ear mechanism, which can provide additional amplification. As opposed to relying on software to generate electric signals and determine frequency as in conventional artificial cochleas, all can be done simultaneously on the film. The structure offers a totally implantable solution, eliminating the need for external equipment and signal strengthening. If supplementary power is required (e.g., for amplification, etc.), human body-based power sources can be used for auxiliary functionality. This auxiliary function can include a signal processing device (not shown) that can control the output of the film and can tune the device based on the individual.

The rationale for the 0.6 mm width of the proposed device is for non-traumatic insertion into the cochlea. The device is to be inserted into the round window to the cochlea. The oval window is avoided as to not damage the ossicles. The implementation of this invention requires that the outer and middle ear be functional, thus the stapes connected to the oval window needs preservation. Surgical techniques can seal the round window after implantation and maintain the natural fluid levels within the cochlea.

In many cases of sensorineural deafness, the low frequency registers of the inner ear still function while the high and middle frequency registers no longer properly respond. In such instances, this device can preserve the functionality of these low frequency components while restoring lost high frequency hearing. The length of the device can be altered to a longer or short length based on the needs of the individual. By changing the length, the device can affect auditory nerves specific to certain frequency ranges. For example, if an individual suffers hearing loss above 2000 Hz, a device can be fabricated to resonate with frequencies above 2000 Hz and inserted only the depth corresponding to these frequencies. Embodiments of the subject innovation can be implanted in a selected portion of the cochlear turn and can function by stimulating a smaller region of the nerves in the inner ear. The preservation of the outer and middle ear results in a less intrusive measure than the currently used series of electrodes; device in accordance with the subject innovation can be completely contained within the cochlea, whereas conventional devices necessitate connectors between the electrode array and receiver structure. The design of embodiments of the subject innovation can readily accommodate future improvements in surgical technology to achieve improved hearing resolution due to the segment sizes and quantity.

When the fabricated piezoelectric film is prepared, a holding device can be used to keep it stable after implantation in the cochlea. Simulation results have shown that without proper boundary conditions, isolation between segments cannot be achieved. Additionally, if the film is not secured in some manner, the piezoelectric film will not vibrate or remain in a constant location to stimulate the correct auditory nerves.

One embodiment of the subject innovation can secure the film between two nonconductive substrates, with a structure similar to current electrode arrays in cochlea implants. The piezoelectric can then be sealed on the boundaries while still subjected to the fluid interactions of the inner ear. Using MEMS techniques, electrodes can be deposited on the piezoelectric film to obtain the necessary charge density, with additional conductive, deposited lines leading from the electrodes on the piezoelectric film to electrodes on the film holder, which would be in closer proximity to the auditory nerves. These paths can also serve as locations for amplification if necessary. The two holding substrates can be held together with a biocompatible silicone epoxy.

What follows is a more detailed discussion of certain systems, methods, and apparatuses associated with aspects of the subject innovation. To aid in the understanding of aspects of the subject innovation, theoretical analysis and experimental results associated with specific experiments that were conducted are discussed herein. However, although for the purposes of obtaining the results discussed herein, specific choices were made as to the selection of various aspects of the experiments and associated setups—such as choice of materials and dimensions—the systems and methods described herein can be employed in other contexts, as well. For example, various aspects of the subject innovation can be utilized to create piezoelectric transducer arrays useable in connection with artificial cochleas. In some embodiments, different selections of materials, configurations, or dimensions can be selected than those used in the experiments discussed herein, and may have differing characteristics, as explained in greater detail below.

Research was conducted that investigated the feasibility of piezoelectric films in achieving adequate voltage output and frequency selectivity to replace the human cochlea. Simulations were run on piezoelectric structures having distinct widths, lengths, and thicknesses. Piezoelectric samples were manufactured for different resonant frequencies and subjected to air vibrations, after which the resulting voltage was recorded. Through both simulated and experimental data, the necessary 5-10 mV to stimulate nerve bundles connected to the hearing centers of the brain was realized. The response spanned the typical human hearing register of 500 to 8500 Hz.

From data sheets of the piezoelectrics used in this research, a material definition for P(VDF-TrFE) was created with Coventorware software, having the proper thermal, piezoelectric, mechanical, and electric characteristics. The piezoelectric properties described above were accurately modeled in the software. The device was then built layer for layer in the same MEMS manner that the actual device can be fabricated, by defining masks, etching layers, and depositing new materials subsequently. With the layers and masks managed, a 3D image of the device was rendered, containing the piezoelectric membrane and defined electrodes.

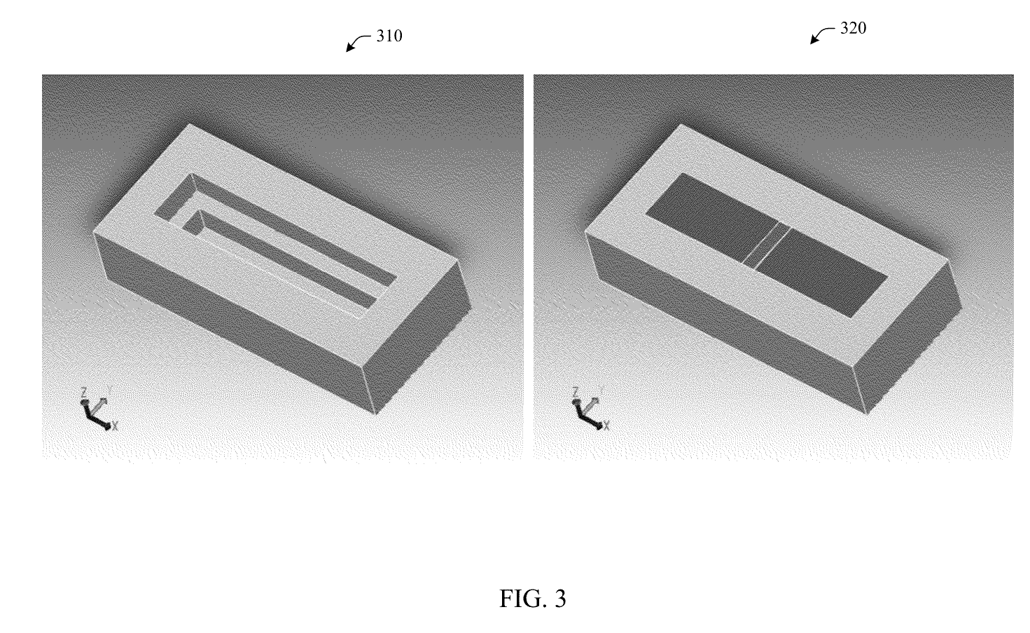

Through the procedures described above, simulations for the experimental devices, described below, were performed over the extreme frequency range for human speech, 500 to 8500 Hz, at increments of 50 Hz. The pressure applied uniformly to the film was the equivalent of 78 dB SPL (sound pressure level), the same pressure to which the experimental samples were exposed. The substrate model dimensions were 20 mm by 50 mm and contained a slit in the center, which was varied in width and length. The boundaries of the piezoelectric were then sealed, such that only a select region of the film would vibrate. FIG. 3 shows the substrate model at 310, with the deposited film and electrode 320. This freely vibrating region had widths of 3 mm, 3.5 mm, 4 mm, 4.5 mm, 5 mm, 5.5 mm, and 6 mm at lengths of 30 mm, again identical to the experimental samples. According to the results of Table 1, greater film widths and longer lengths reduced the resonant frequency; the increased film size introduced a greater load.

TABLE 1
Simulated results based on film width at
constant 40 μm thickness and 30 mm length

| | Film Width | | | | | | |
|---|---|---|---|---|---|---|---|
| | 3 mm | 3.5 mm | 4 mm | 4.5 mm | 5 mm | 5.5 mm | 6 mm |
| Output (μm) | 1.618 | 4.87 | 4.534 | 3.75 | 4.35 | 3.21 | 4.17 |
| Frequency | 6427 | 4562 | 3387 | 2980 | 2535 | 2292 | 1652 |

These CoventorWare simulations suggest that the resonant frequency of the piezoelectric material under investigation can predictably be controlled by changing the width of the material.

As described above, thinning the film is one of the key concepts for increasing the voltage output, while simultaneously reducing the interference from different segments. The thinner film theoretically produces superior voltage as the membrane is less resistant to displacement; therefore, the film will deform more readily and create a higher potential difference.

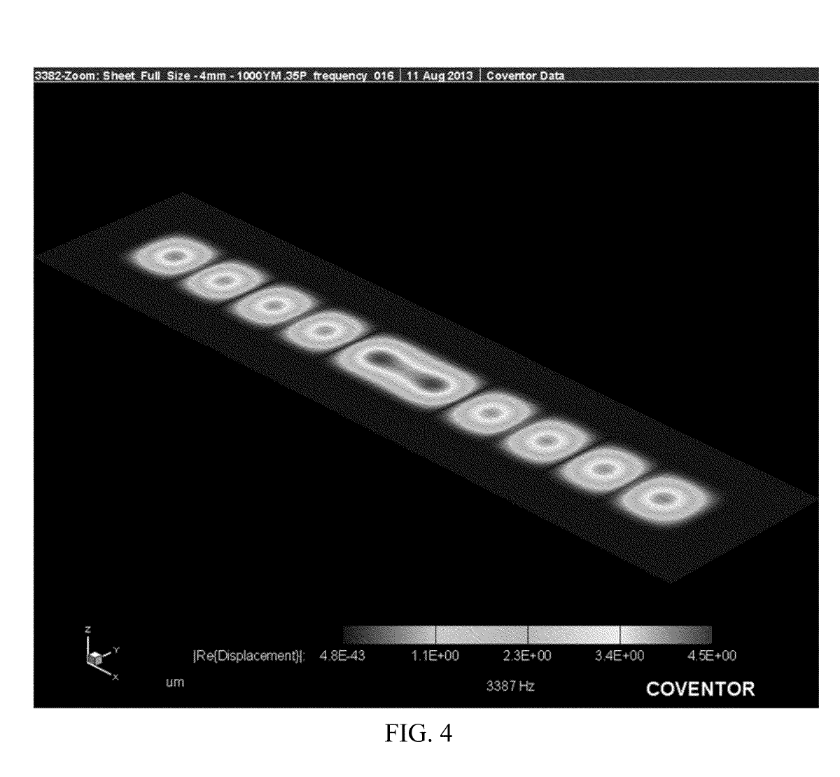

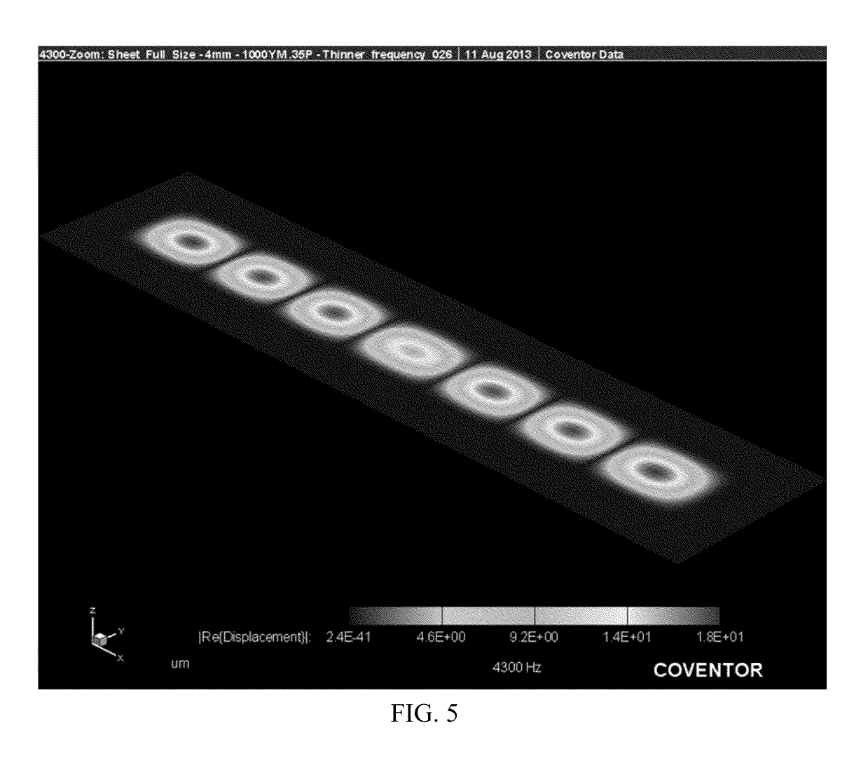

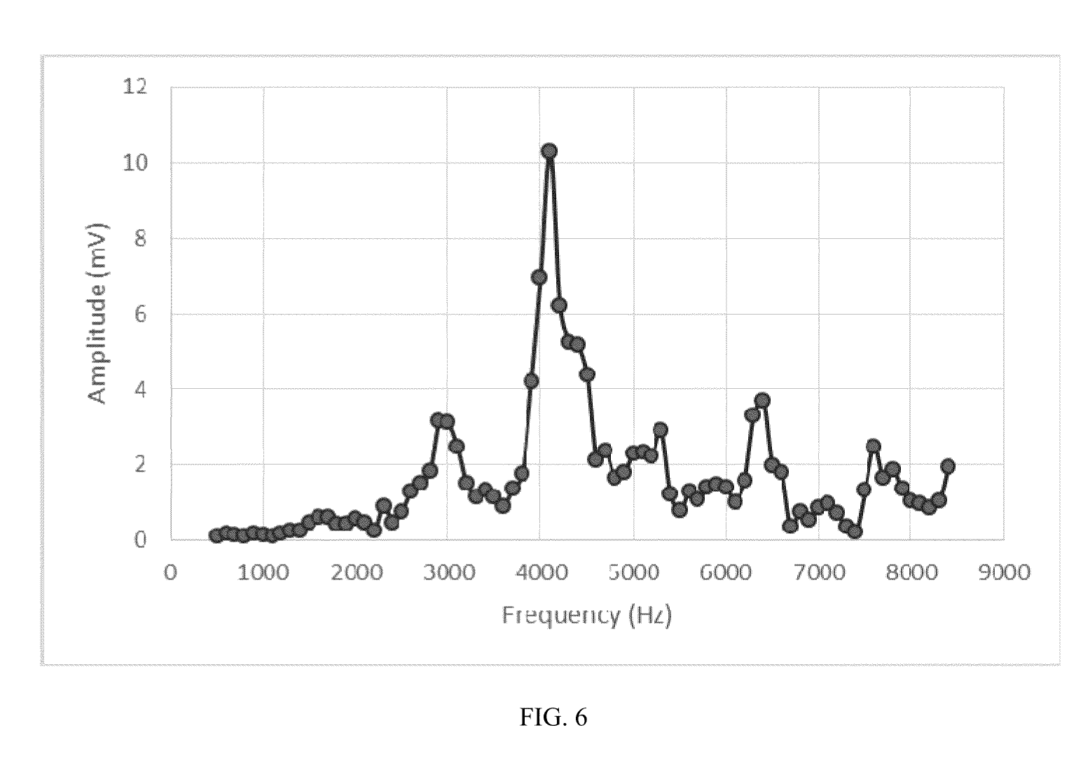

The simulations were originally run as described above using 40 micron-thick films. A visual representation of the 40 micron response is shown in FIG. 4. In the simulation shown in FIG. 5, the thickness was changed to 20 microns, while the sample holder dimensions, electrode size, and fixed boundaries remained unaltered. Over the same frequency range, the maximum output of the 20 micron film is given in FIG. 6 at a displacement of 18.416 microns, compared to 4.5 microns produced by the 40 micron film. The 20 micron-thick film of FIG. 5 produced an output over 4 times larger than the 40 micron-thick counterpart.

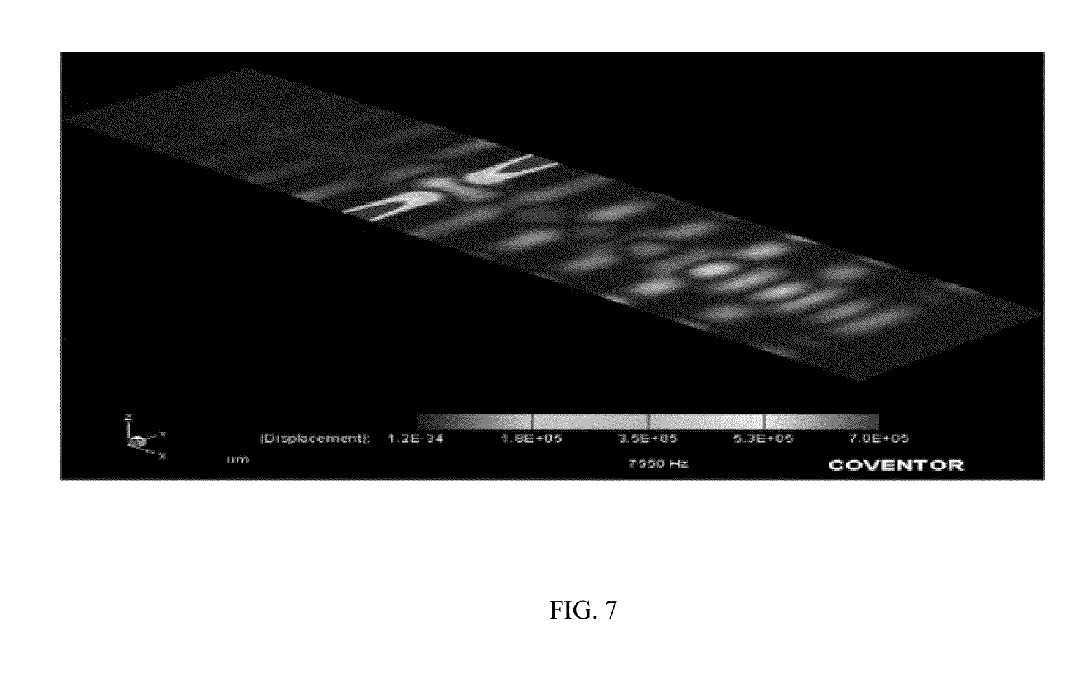

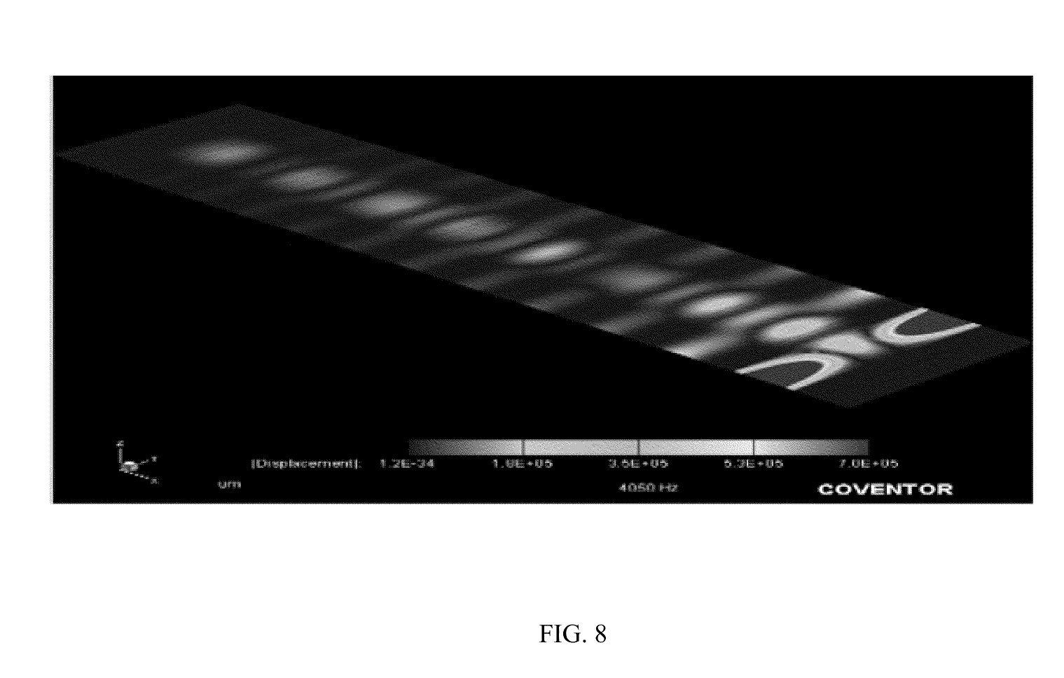

Simulations were also run to analyze the fabricated model from FIG. 1. As shown in a 12 segment example, the etches in the film reduced the output of neighboring segments, isolating the resonance to one segment, as given by FIG. 7 and FIG. 8 for high and low frequency examples, respectively. The simulation confirmed that the proposed structure can offer isolation and frequency selectivity determined by the dimensions of the segments.

Experimental results were additionally gained to compare to the simulations. PVDF-TrFE was chosen as the experimental material based on several characteristics, although in various embodiments, other materials could alternatively be used. Uniform sample holders were produced that had variable widths for the regions of vibration made in the holder, allowing the size of the film to be controlled.

Once samples were prepared, they were secured below a speaker, producing the vibrations to displace the piezoelectric. This speaker was powered a signal generator to control both the amplitude and the frequency of the signal. Measurements were systematically taken by starting the signal generator at the lowest frequency and simultaneously applying the voltage correction for constant SPL as frequency increased; this process was then repeated for each frequency up to the maximum of 8500 Hz. The results were then amplified for easy visibility and fed into both a multimeter and spectrum analyzer to be recorded. The experimental work was targeted towards verifying the electrical output and frequency response of piezoelectric film, altered in width, thickness, and length.

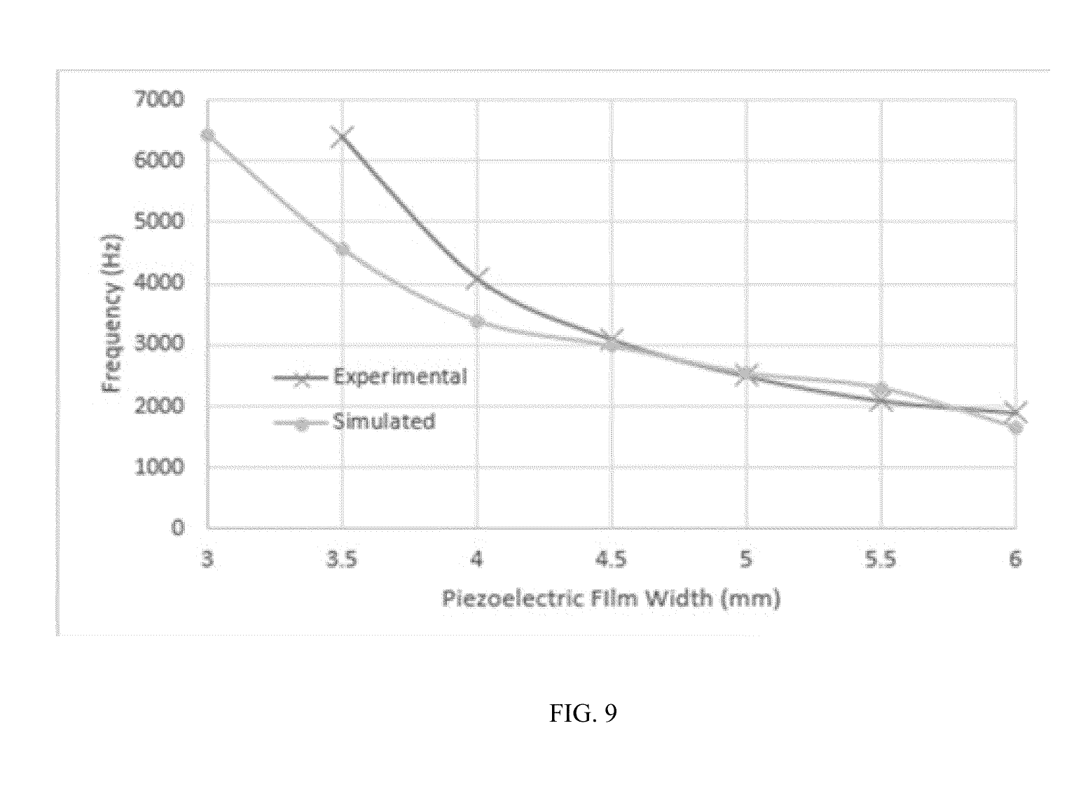

The maximum output of the films was found to be 10.4 mV and three films were produced which had resonant frequencies at 1900, 4100, and 6400 Hz at widths of 3.5 mm, 4 mm, and 6 mm, respectively. These responses are compared to the simulated results in FIG. 9.

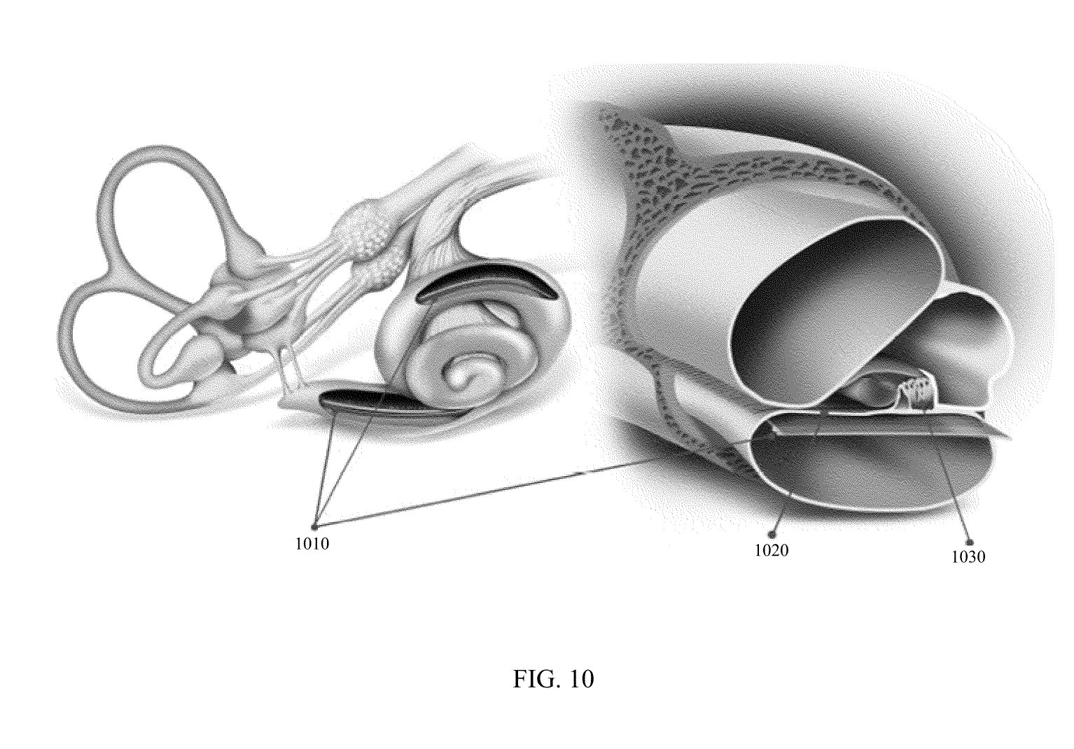

Based on the theoretical and experimental analysis discussed herein, the potential of fabricating frequency selective piezoelectric segments has been verified, and their voltage generation at resonance is within the necessary bounds at a maximum of 10.4 mV as shown in FIG. 6. FIG. 10 illustrates an example placement of a cochlear implant 1010 according to aspects of the subject innovation, showing the example implant 1010 in proximity to the basilar membrane 1020 and Organ of Corti 1030.

As the effect of the fluids, location of the device in relation to the auditory nerves during implantation, and smaller film segments due to increasing the segment number could potentially reduce the output of the piezoelectric film, amplification could be beneficial. Due to this, human body-available power sources can be employed in accordance with various aspects of the subject innovation, which can include thermal, vibrational, or electrochemical means, such as through the stria vascularis. A minimal power amplifier can be used to reach the necessary output. This class of amplifier can run from μW of power.

In various embodiments, aspects of the subject innovation can provide a novel technique for hearing restoration with multiple advantages over conventional devices and methods. Aspects of the subject innovation can include minimally invasive techniques and devices which can preserve residual hearing, and such devices can be totally implantable without the requirement for microphones or batteries. Compared with conventional devices, reproduction of sound can be more normal, with substantial improvement in reproduction of speech and music. Various aspects of the subject innovation can provide techniques of hearing restoration that can use the component(s) of the auditory pathway which are functional and replace only the component(s) which are non-functional. Among other groups, the subject innovation can be of substantial benefit to patients with moderate to severe nerve deafness caused by age or noise exposure, which is the overwhelming majority of the hearing impaired worldwide.

Aspects of the subject innovation can employ or comprise thin film, biocompatible piezoelectric devices, which can include frequency-specific trenches spaced along the length of the film. In various embodiments, devices as described herein can be inserted into the cochlea in an atraumatic manner and can rest along the under surface of the proximal portion of the basilar membrane. In various aspects, frequencies above 1-2 kHz can be stimulated along the proximal portion of the basilar membrane, while frequencies lower than 1-2 kHz can be preserved only the apical portion of the basilar membrane, with electrical charge from the piezoelectric device stimulating the neurons of the auditory nerve. Compared to conventional hearing aids and cochlear implants, an artificial cochlea according to aspects of the subject innovation can provide multiple advantages. Hearing aids and cochlear implants require external microphones and an outside power source, which are not required by the subject innovation. Additionally, hearing aids and cochlear implants can cause possible physical discomfort from the device and raise cosmetic concerns, both of which can be avoided with the subject innovation. The possibilities of difficulty hearing in noisy environments or distortion of sounds which occur with hearing aids and cochlear implants are less likely with an artificial cochlea as described herein, and the likelihood of a restoration of normal hearing is increased. Additionally, in contrast with cochlear implants, the subject innovation does not destroy any residual hearing remaining prior to implantation.

What has been described above includes examples of the innovation. It is, of course, not possible to describe every conceivable combination of components or methodologies for purposes of describing the subject innovation, but one of ordinary skill in the art may recognize that many further combinations and permutations of the innovation are possible. Accordingly, the innovation is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A device, comprising:
a piezoelectric film comprising a plurality of segments, wherein adjacent segments are separated by a trench of a plurality of trenches in the piezoelectric film; and
a plurality of electrodes attached to the plurality of segments.

2. The device of claim 1, wherein the lengths of the plurality of segments monotonically increases along the length of the piezoelectric film.

3. The device of claim 1, wherein the plurality of segments comprises at least nine segments.

4. The device of claim 1, wherein resonant frequencies of each of the plurality of segments are in a range from 300 Hz to 3500 Hz.

5. The device of claim 1, wherein the piezoelectric film comprises a piezoelectric polymer.

6. The device of claim 1, further comprising at least one of a substrate or a holder, wherein the piezoelectric film is secured to the at least one of the substrate or the holder.

7. The device of claim 1, wherein the plurality of trenches have widths of 10 microns or less.

8. The device of claim 1, wherein the plurality of segments have thicknesses of 40 microns or less.

9. The device of claim 8, wherein the plurality of segments have a thickness of 20 microns or less.

10. The device of claim 1, further comprising an amplifier that amplifies outputs from the plurality of segments.

11. The device of claim 10, further comprising a thermal power source that provides power to the amplifier.

12. A method, comprising:
obtaining a piezoelectric film;
etching a plurality of trenches in the piezoelectric film, wherein the plurality of trenches defines a plurality of segments of the piezoelectric film; and
attaching a plurality of electrodes to the plurality of segments.

13. The method of claim 11, wherein the lengths of the plurality of segments monotonically increases along the length of the piezoelectric film.

14. The method of claim 11, wherein the plurality of segments comprises at least nine segments.

15. The method of claim 11, wherein resonant frequencies of each of the plurality of segments are in a range from 300 Hz to 3500 Hz.

16. The method of claim 12, wherein the piezoelectric film comprises a piezoelectric polymer.

17. The method of claim 12, further comprising securing the piezoelectric film to at least one of a holder or a substrate.

18. The method of claim 12, wherein the plurality of trenches have widths of 10 microns or less.

19. The method of claim 12, wherein the plurality of segments have thicknesses of 40 microns or less.

20. The method of claim 19, wherein the plurality of segments have a thickness of 20 microns or less.
